(19) United States
(12) Patent Application Publication
(10) Pub. No.: US 2019/0044895 A1
(43) Pub. Date: Feb. 7, 2019

(54) Emotional Support System

(71) Applicant: Patty Gibbs, Davenport, IA (US)

(72) Inventor: Patty Gibbs, Davenport, IA (US)

(21) Appl. No.: 15/668,166

(22) Filed: Aug. 3, 2017

(51) Int. Cl. H04L 12/58; G06Q 50/22

(52) U.S. Cl. CPC H04L 51/02; G06Q 50/22

(57) ABSTRACT

The present invention relates to system for coping with crisis. The system comprises a plurality of communications including various messages that are delivered to the persons dealing with the crisis. The communications include messages, e.g., identification messages, assessment messages, strategy messages, release messages, and in some embodiments memorializing messages. The various communications of the system are provided to the recipient at different times, and may include one or more of the types of messages in one or more of the communications.

### FIELD OF THE INVENTION

The present invention relates to a system for providing emotional support and counseling for dealing with crises, such as grief due to loss of a loved one.

### BACKGROUND OF THE INVENTION

Personal crises, such as that due to loss, are experiences that virtually every person will encounter at some point in their lives. Such losses can range from the trivial to the life-changing, such as the loss of a loved one due to death or other separation. Crises such as the loss of employment or one's home due to natural disaster may also be faced. Such losses often results in the person experiencing emotional crisis of such severity that counseling may be required to deal with the crisis. Many people, however, fail to seek counseling because of the expense, the time commitment, lack of availability, immobility, introversion, because the person does not recognize that he or she is suffering from the inability to adequately address his or her emotions from his or her loss, or because the person simply does not know where to start in the grieving process. In some communities, especially economically disadvantaged communities, may simply not have the resources available to address personal crises.

### SUMMARY OF THE INVENTION

According to the principle of the invention, a counseling system for a person dealing with a crisis is provided. The system comprises a plurality of communications including various messages that are delivered to the persons dealing with the crisis. The messages in the communications inform both the suffering individual and his or her support group about the issues with which they are being presented. The messages are designed to encourage and support people dealing with their crisis. They are designed to comfort those feeling alone and overwhelmed and provide consolation and direction. The messages are designed to help people to face their emotions, work through it and release it while understanding that they are not alone and gain closure. The messages in the communications also validate the challenge of their crisis and thoughts and feelings experienced throughout the process to assure people that their emotions are normal and assure them that they can work through it.

The plurality of communications are delivered at intervals intended to correlate with the stages typically encountered by persons dealing with a crisis. For example, persons dealing with the crisis of loss of a loved one often experience grief, which is often described as including five stages—denial, anger, bargaining, depression, and acceptance. It is appreciated that such stages generally present a framework for addressing the grief experienced, such as with the loss of a loved one. These categories are tools to help one frame and identify what is being experienced.

As stated, crises may take other forms other than the loss of a loved one. For example, one may be facing crisis due to the loss of a job, the relocation of a loved one, or issues caused by substance or other types of abuse. The stages of such crises may differ from those of grief, but may be addressed by the present system in the same manner through the system of communications with particular messages.

The system of the present invention includes a plurality of communications that are provided to the person in crisis in series. The communications may take the form of cards, similar to greeting cards. The communications may also be provided electronically. Each of the communications includes at least one message. These messages may include an identification message, an assessment message, a strategy message, a release message, and a memorializing message. Preferably each of the plurality of communications includes one or more messages of different types.

The identification message preferably introduces the recipient to the idea that he or she may be suffering a crisis. The identification message further explains the concept of a support system and provides suggestions for the recipient to identify his or her support system.

The assessment message provides information for identifying issues encountered with the crisis. For example, the assessment message may provide information regarding the stages of grief so that the recipient can better identify the status of his or her grief. Just by way of example, the assessment message may include information regarding signs of depression, as opposed to the more common feelings of grief, so that proper treatment can be given. This is because the loss of a loved one due to death, the loss of a job or the end of a relationship, etc., commonly triggers feelings of sadness or causes grief to develop. While many suffering from common grief may describe themselves as being depressed, sadness and grief are different from actual depression, but share many characteristics. With grief, unlike depression, painful feelings come in waves, often intermixed with positive memories of the deceased. By contrast, with depression, mood may be affected on an almost constant basis for weeks. Also, with grief, one's self-esteem is usually maintained, whereas feelings of worthlessness are common with major depression. The assessment message may provide information to enable the recipient or his or her support system to assess whether additional help for depression is needed. In a preferred embodiment, the assessment message is provided in an initial communication.

The strategy message preferably provides the recipient with information regarding how he or she may deal with the particular feelings being experienced during the crisis. For example, for addressing the crisis of losing a loved one, the strategy message may suggest that the recipient collect items that remind him or her of the lost loved one, e.g., correspondence, photos, music shared, gifts, or the like, and that he or she go through such keepsakes when feeling sad and remember happier moments. As stated, crisis can take the form of temporary loss of a loved one, such as a child going away to school. In this case, the strategy message may include suggestions for the parent on keeping in communication with his or her child while away at school. A strategy message for the loss of a job may include suggestions on how to get a new job. In a preferred embodiment, strategy messages may be included across several communications.

In some embodiments of the present system, a memorializing message may be provided that offers suggestions for memorializing the lost one. For example, the message may provide suggestions for processing thoughts and feelings of the loved one through art, writing, or other activities that honor and commemorate the lost loved one, such as planting a tree. In a preferred embodiment, the memorializing message is included in a communication provided in one or more communications to the individual later in the healing process.

The release message preferably provides information for concluding the crisis. For example, the loss of a loved one may be released by the symbolic exercise of writing a goodbye letter to the loved one or composing a thought for the loved one that is set free with a balloon, or lighting a candle and setting it off on a raft. With a child being away at school, the release message may be the sending of a congratulations message for completing a year of school. While symbolic in nature, the physical manifestation of a release often brings a sense of closure to the crisis. Concluding the crises does not necessarily mean that the loss is forgotten or entirely resolved, but instead, that the individual accepts the loss and develops healthy coping skills to move forward.

The various communications of the system are provided to the recipient at different times, and may include one or more of the types of messages in one or more of the communications. With regard to the loss of a loved one, the messages may be delivered monthly for a year. With a child away at school, cards may be spaced during the school year. Other time intervals may be used depending on the crisis.

The present system presents various advantages. Counseling can be tailored to the needs of all people of various cultures, ages, gender, race and socio-economic backgrounds accommodating each grief stage. Each intervention gives a step by step process in which to address the crisis. When devastating events occur in families, usually each individual is consumed with their own emotions and each is left to deal with it on their own. Due to having the counseling strategies included in the message, each individual affected by the loss can be assisted to work through the crisis with their own message. People in the suffering person's support system may also use the messages to better understand what the suffering person is going through, as well as how to get through the crisis. In the case of children, messages may be specifically designed in child-like language to assist them to effectively work through the grief process either independently or with the help of an adult. Their cards also consist of activities on their age-appropriate level providing them with ways of releasing their grief and turning their attention to a positive focus. Unlike traditional counseling, no appointments are necessary. Moreover, unlike traditional counseling, the individual retains the communications so the individual may refer back to the messages in the communications at any time, and not only during a counseling session.

There has thus been outlined, rather broadly, certain features of the invention in order that the detailed description thereof that follows may be better understood, and in order that the present contribution to the art may be better appreciated. There are, of course, additional features of the invention that will be described hereinafter and which will form the subject matter of the claims appended hereto. Those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an embodiment of a preferred system of communications according to the present invention related to the loss of a loved one.

FIG. 2 is a preferred embodiment of an identification message for the embodiment of FIG. 1

FIG. 3 is a preferred embodiment of an assessment message for the embodiment of FIG. 1.

FIG. 4 is a preferred embodiment of a strategy message for the embodiment of FIG. 1.

FIG. 5 is a preferred embodiment of a memorializing message for the embodiment of FIG. 1.

FIG. 6 is a preferred embodiment of a release message for the embodiment of FIG. 1.

FIG. 7 is an embodiment of a preferred system of communications according to the present invention related to a parent's loss felt from a child being away at school.

FIG. 8 is a preferred embodiment of an identification message for the embodiment of FIG. 7

FIG. 9 is a preferred embodiment of an assessment message for the embodiment of FIG. 7.

FIG. 10 is a preferred embodiment of a strategy message for the embodiment of FIG. 7.

FIG. 11 is a preferred embodiment of a release message for the embodiment of FIG. 7.

FIG. 12 is an embodiment of a preferred system of communications according to the present invention related to a child's feelings while away at school.

FIG. 13 is a preferred embodiment of an identification message for the embodiment of FIG. 12.

FIG. 14 is a preferred embodiment of an assessment message for the embodiment of FIG. 12.

FIG. 15 is a preferred embodiment of a strategy message for the embodiment of FIG. 12.

FIG. 16 is a preferred embodiment of a release message for the embodiment of FIG. 12.

FIG. 17 is an embodiment of a preferred system of communications according to the present invention related to the loss of a pet.

FIG. 18 is a preferred embodiment of an identification message for the embodiment of FIG. 17.

FIG. 19 is a preferred embodiment of an assessment message for the embodiment of FIG. 17.

FIG. 20 is a preferred embodiment of a strategy message for the embodiment of FIG. 17.

FIG. 21 is a preferred embodiment of a memorializing message and release message for the embodiment of FIG. 17.

### DETAILED DESCRIPTION

Before the preferred embodiment of the present invention is described, it is to be understood that the claimed apparatus is not limited to specific embodiment discussed, specific components, or to particular implementations. It is also to be understood that the terminology used herein is for the purpose of describing particular embodiments only and is not intended to be limiting.

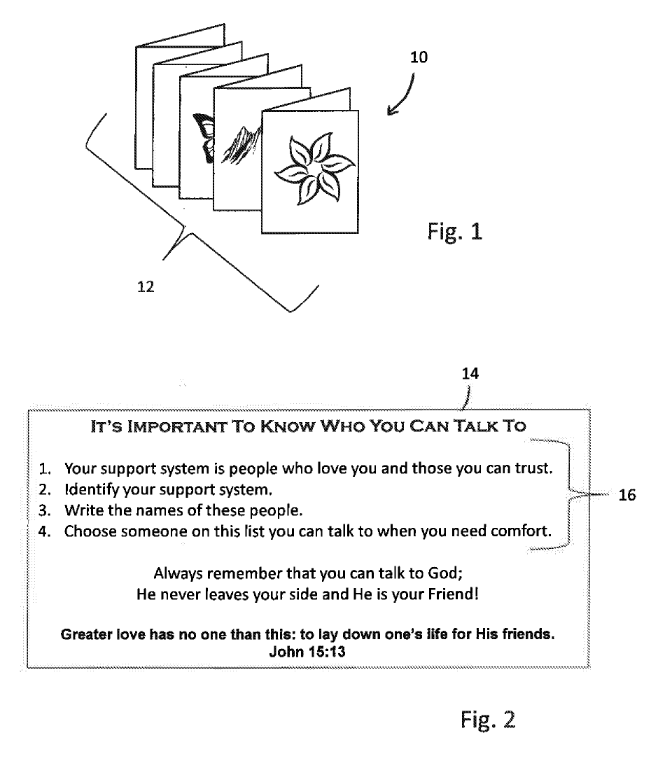

One embodiment of the preferred invention is discussed with respect to FIG. 1. In this embodiment, the system of communications according relates to the loss of a loved one. System 10 includes a plurality of communications 12. In this embodiment, the communications are provided in the form of greeting-type cards.

Referring to FIG. 2, communication 14, which is one of the plurality of communications 12 from FIG. 1, is a preferred example of a first card that may be provided to a person that has suffered the loss of a loved one. An identification message 16 is shown. Identification message 16 introduces the recipient to the idea that he or she may be suffering from a crisis, and further explains the concept of a support system and provides suggestions for the recipient to identify his or her support system.

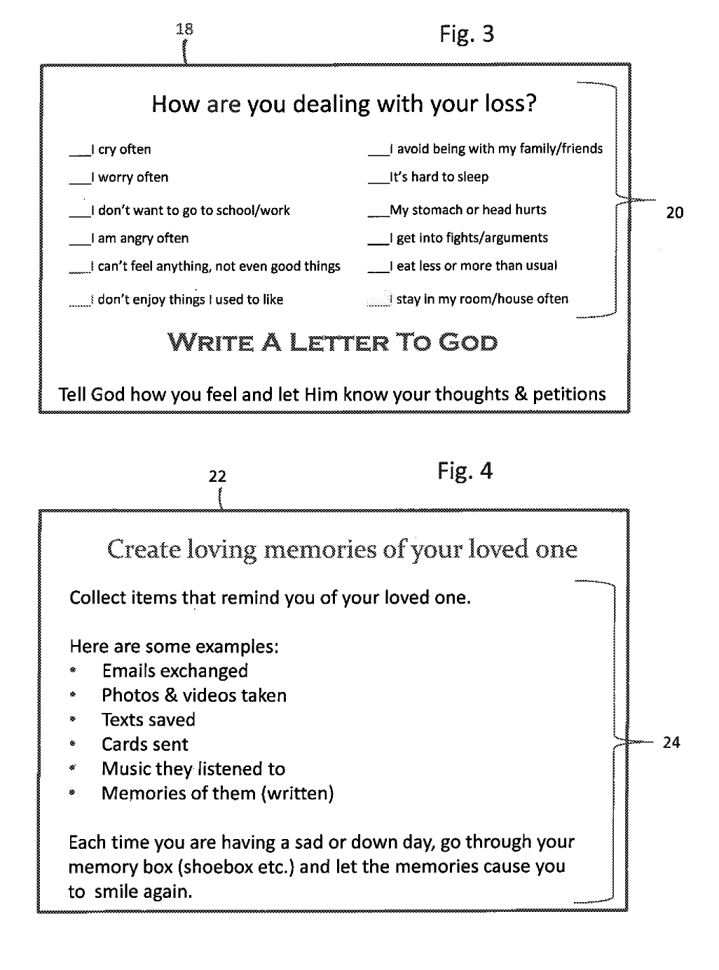

Referring to FIG. 3, communication 18, which is also one of the plurality of communications 12 from FIG. 1, depicts an example of a communication that includes an assessment message 20. The assessment message provides information related to issues often felt when dealing with the loss of a loved one. Although not shown in this particular embodiment, the assessment message may also provide information that enables the recipient or his or her support system to assess whether the individual is depressed and may need to seek additional help.

Referring to FIG. 4, communication 22 is an example of a strategy message 24 for addressing the loss of a loved one. As shown, in this message, the individual is encouraged to collect items that remind him or, her of their loved one, such as emails, photos, cards, or music. The individual is also instructed to refer to the collected memories when a feeling of sadness is experienced.

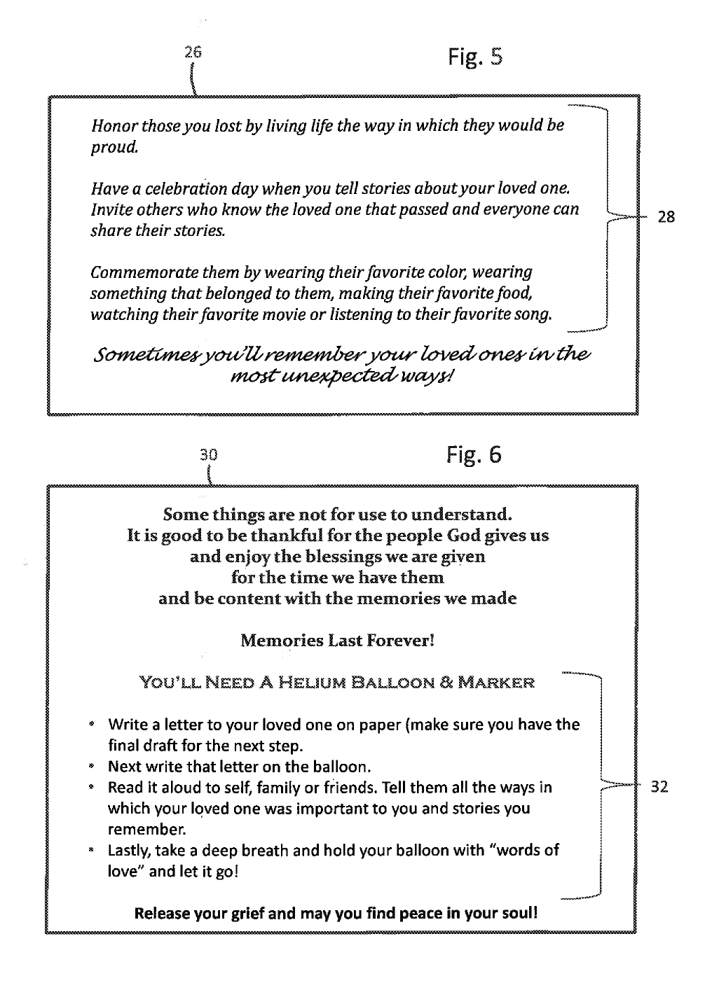

In some embodiments, a communication with a memorializing message may be included. For example, referring to FIG. 5, communication 26 includes a memorializing message 28 that suggests that the individual organize a celebration day to honor and share in the memories of the person lost to commemorate the lost loved one.

To bring a sense of closure, a communication may include a release message. As shown in FIG. 6, communication 30 includes a release message 32, which suggests writing a letter to the loved one, attaching it to a helium balloon, and then setting balloon free.

While the different messages are shown in separate communications, it should be understood that any of the communications may include one or more of the types of messages. It should further be understood that a particular type of message, e.g., assessment, release, memorialization, can be included in multiple communications to address different stages of the grieving process.

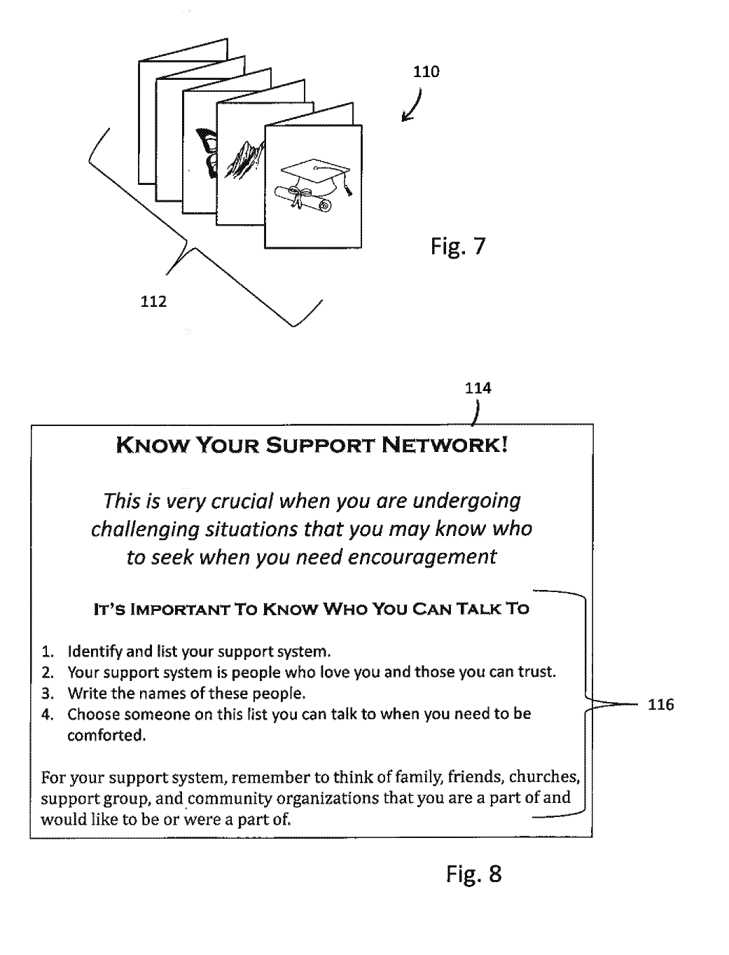

Another embodiment of the preferred invention is discussed with respect to FIG. 7. In this embodiment, the system of communications according relates to the feelings of loss or uncertainty related to a parent's loss felt from a child being away at school, such as when the child goes off to college. As with the previous embodiment, system 110 includes a plurality of communications 112. In this embodiment, the communications are provided by way of electronic messages.

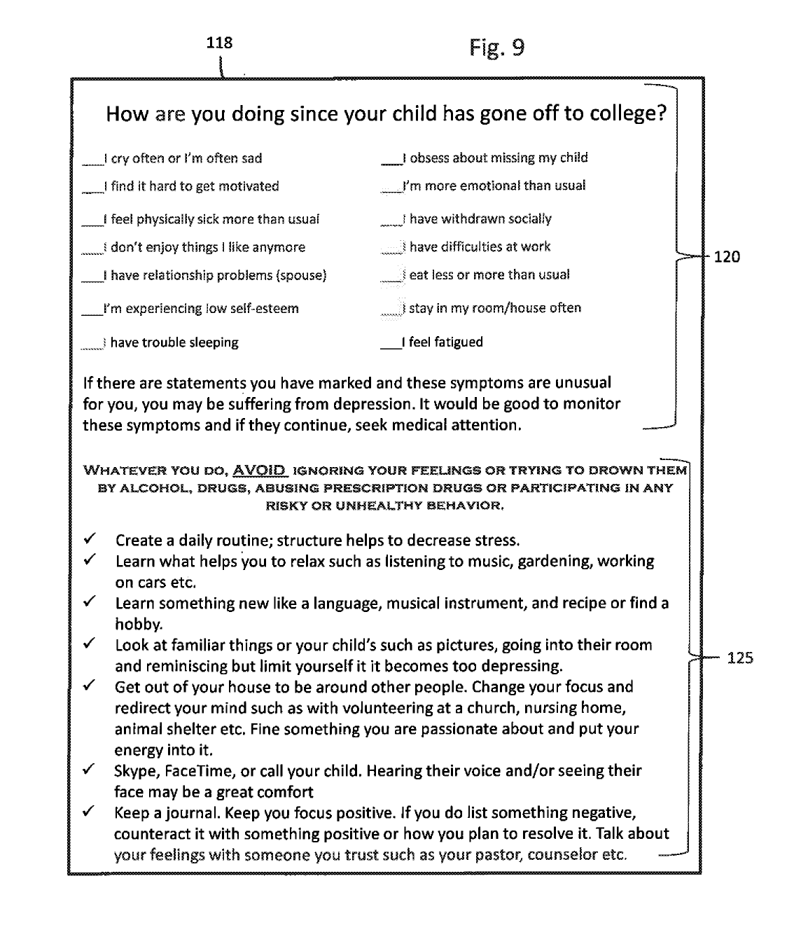

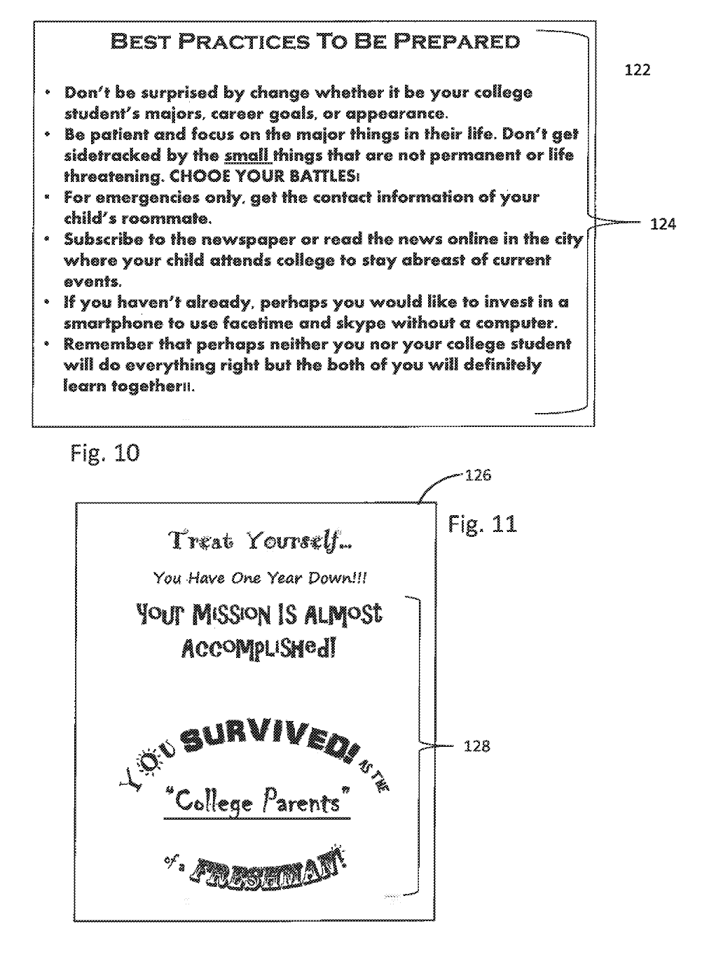

Communication 114, as shown in FIG. 8, includes an identification message 116 which explains that he or she may be suffering a feeling of loss from the fact that the child is away at college. As shown in FIG. 9, communication 118 provides assessment message 120 that explains several issues that the individual may be feelings relative to the child away at school. Referring to FIG. 10, communication 122 provides a strategy message 124 to enable the parent to deal with the fact that the child is away for school and that his or her presence in their lives has changed substantially. Referring back to FIG. 9, communication 118 also includes a strategy message 125. As shown, in this message, the individual is given suggestions regarding how to deal with the stress of a child away at school.

Communication 126 in FIG. 11 depicts an exemplary release message 128. In this embodiment, the release message 128 comprises writing a congratulatory note to the parent for surviving their child's year of school, which allows the parent to share in the accomplishments of the child to create the sense that the child was not completely separate from the home.

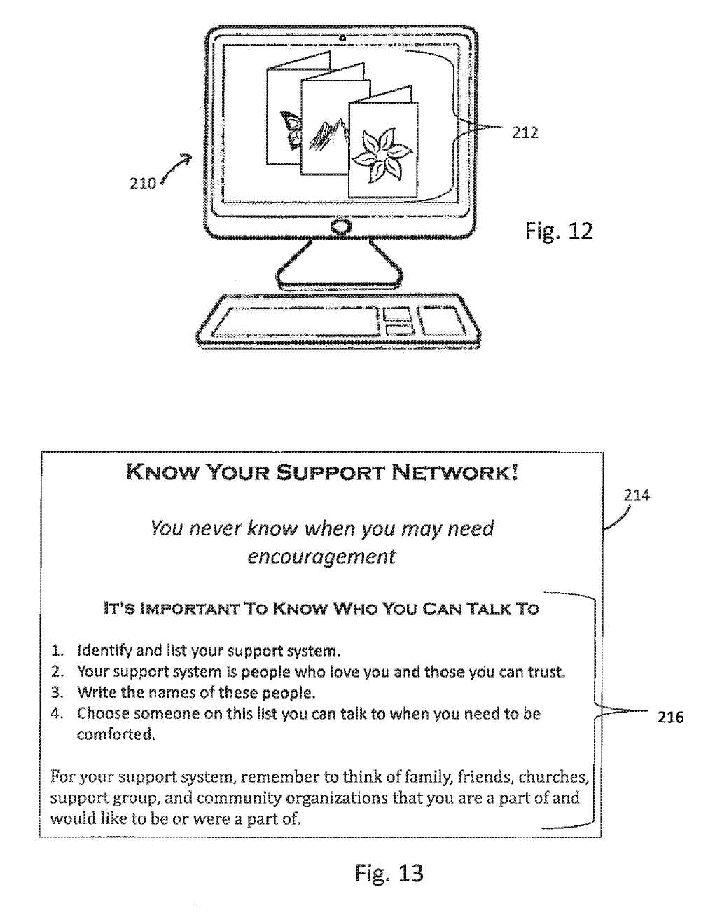

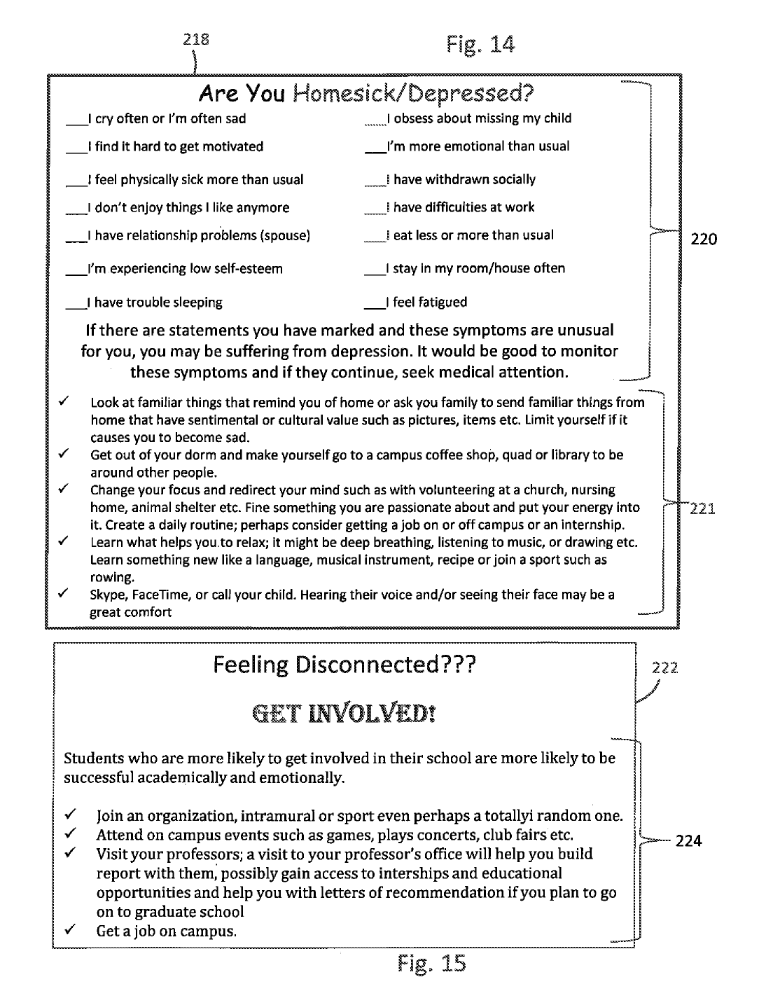

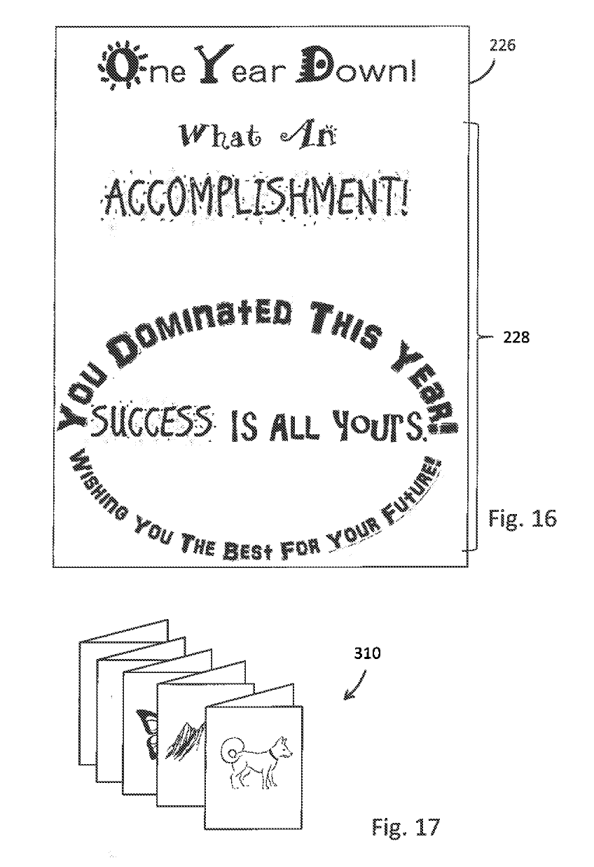

Referring to FIG. 12, system 210 includes a plurality of communications 212 for the student away from home. Although a plurality of communications are shown, they may be delivered one at a time. Communication 214, as shown in FIG. 13, includes an identification message 216 to instruct the child that he or she may be suffering a feeling of loss from the fact that he or she is away from home for the first time for a prolonged period of time, and does not have the everyday support of his or her parents and home. It further helps identify potential support systems. As shown in FIG. 14, communication 218 provides assessment message 220 to provide context for several issues that the child may be feelings relative to being away from home and family. In this embodiment, communication 218 also includes strategy message 221. Referring to FIG. 15, communication 222 provides another strategy message 224 to enable the child to deal with being on his or her own. As shown, in this message, the individual is given suggestions such as joining school organizations, getting a job, and volunteering. Communication 226 in FIG. 16 depicts an exemplary release message 228. In this embodiment, the release message 228 comprises a congratulatory note to the student.

The present invention enables one to cater to the particular recipient. For example, a younger person, such as a child may suffer a crisis due to the loss of a loved one like a relative, friend, or pet. Referring to FIG. 17, system 310 includes a plurality of communications 312 related to the loss of a pet. As before, the communications 312 are provided in the form of greeting-type cards. Although not shown, it should be appreciated that these communications 312, as well as any of the aforementioned communications can take the form of an electronic card, mail, presentation, photograph, video, or the like. In contrast to the earlier embodiments, the verbiage provided is directed to the emotions and understanding of a young child.

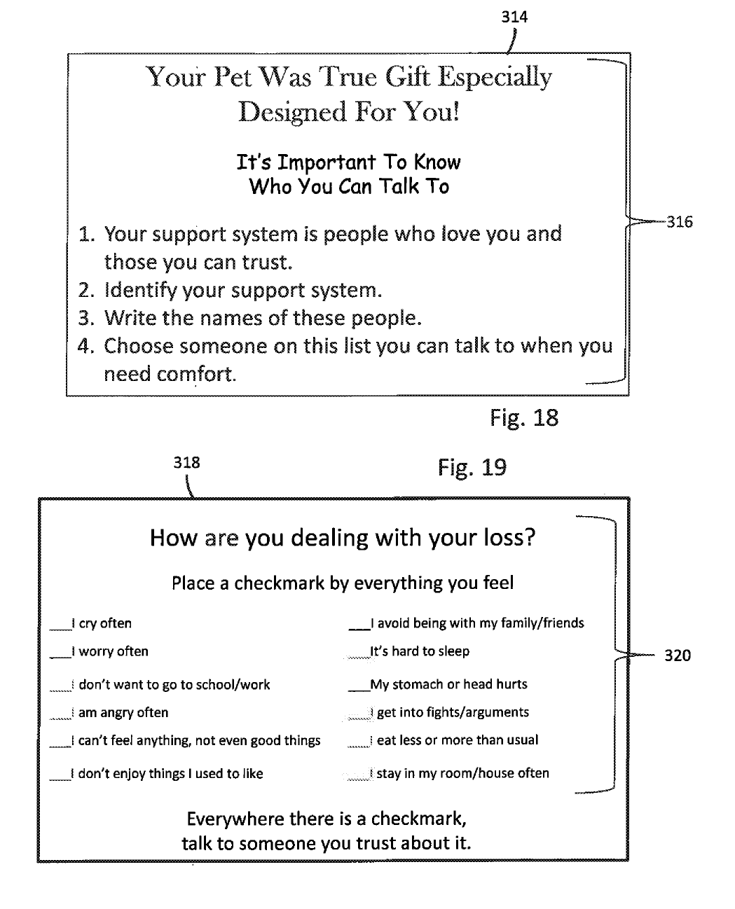

Referring to FIG. 18, communication 314 is a preferred example of a first card that may be provided to in individual that has lost a pet. The identification message 316 introduces the person to the idea that he or she may be suffering from a crisis and further explains the concept of a support system and provides suggestions for the recipient to identify his or her support system.

Referring to FIG. 19, communication 318 provides an example of an assessment message 320. The assessment message provides information related to issues that a person may feel when dealing with the loss of pet. In some embodiments, the assessment message 320, as well as the other messages in this embodiment, can be tailored to a child that has lost a pet by presenting the information in a form that is both understandable and usable by a younger child, as well as by an adult caretaker.

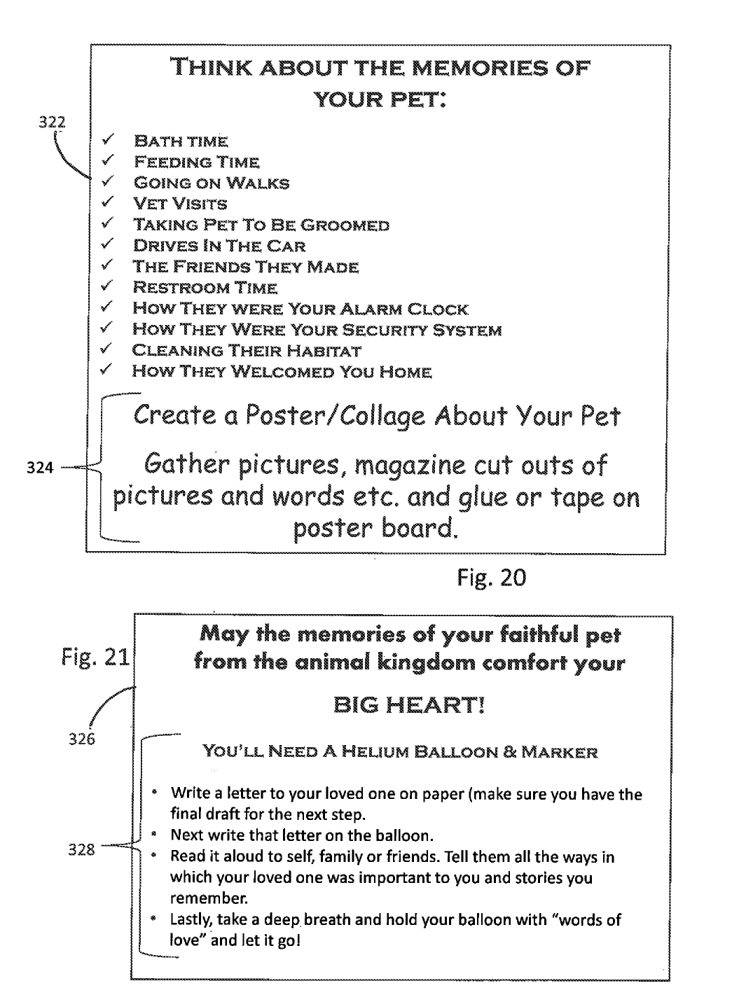

Referring to FIG. 20, communication 322 is an example of a strategy message 324 for addressing the loss of the pet. As shown, in this message, the individual is instructed to gather pictures, and descriptive words for their pet. This strategy message is also a memorializing message, which suggests creating a poster to honor and remember the pet. As before, a communication may include a release message. As shown in FIG. 21, communication 330 includes a release message 332, which suggests writing a note to the loved one, tying it to a balloon, and releasing the balloon.

While the different messages are shown in separate communications, it should be understood that any of the communications may include one or more of the types of messages. It should further be understood that a particular type of message, e.g., assessment, release, memorialization, can be included in multiple communications to address different stages of the grieving process. In some embodiments, one or more of the plurality of communications may include each type of message to assist the individual to deal with a particular stage of the crisis, such as a stage of grief. Just by way of example, one of the commonly accepted stages of grief is denial. A particular communication may include an identification message, an assessment message, a strategy message, a memorializing message, and a release message for the denial stage. A later communication may also include an identification message, an assessment message, a strategy message, a memorializing message, and a release message for a later stage of grief, such as anger.

It should further be understood that a particular message may include one or more types of messages. For example, a strategy message and a memorializing message may be presented in a single statement.

Having described this invention in detail, those skilled in the art will appreciate that numerous modifications may be made of this invention without departing from the spirit of the invention. Therefore, it is not intended that the breadth of the invention be limited to the specific embodiments illustrated and described. Rather, the scope of the invention is to be determined by appended claims and their equivalents.

I claim:

1. A counseling system for a person coping with a crisis, the system comprising:
a plurality of communications to be provided over time, wherein:
at least one of the plurality of communications includes an identification message providing information for identifying the nature of the crisis;
at least one of the plurality of communications includes an assessment message providing information for identifying issues encountered with the crisis;
at least one of the plurality of communications includes a strategy message providing information for addressing issues encountered with the crisis; and
at least one of the plurality of communications includes a release message providing information for concluding the crisis;
each of the plurality of communications being deliverable to the person at separate times.

2. The counseling system of claim 1, wherein the plurality of communications further includes at least one of a memorializing message providing information for recording information related to the crisis.

3. The counseling system of claim 1, wherein the communications are delivered as cards.

4. The counseling system of claim 1, wherein the communications are delivered in electronic form.

4. The counseling system of claim 1, wherein the crisis is one of an absence of a person, an absence of an animal, or substance abuse.

5. A system configured to assist a person to cope with a crisis due to a loss, the system comprising:
a first communication comprising an identification message, the identification message providing the person with information related to identification of the nature of the crisis;
a second communication comprising an assessment message, the assessment message providing the person with information related to identification of possible issues being encountered with the crisis;
a third communication comprising a strategy message, the strategy message providing the person with information related to addressing issues being encountered with the crisis; and
a fourth communication comprising a release message, the release message providing the person with information related to concluding the crisis;
the first communication, second communication, third communication, and fourth communication adapted to be acted on by the person at separate times.

6. The system of claim 5, further comprising a fifth communication comprising a memorialization message, the memorialization message providing the person with information related to wherein the plurality of communications further includes at least one of a memorializing message providing information for preserving the memory of the loss.

7. The system of claim 6, wherein at least one of the first communication, second communication, third communication, and fourth communication is a card.

8. The system of claim 6, wherein at least one of the first communication, second communication, third communication, and fourth communication is an electronic file.

9. The system of claim 8, wherein the electronic file is one of an electronic document, electronic mail, a digital photograph, or a video.

10. The system of claim 1, wherein the crisis is one of an absence of a person, an absence of an animal, or substance abuse.
